(19) United States
(12) Patent Application Publication
(10) Pub. No.: US 2010/0118832 A1
(43) Pub. Date: May 13, 2010

(54) Method for connection termination in mobile IP

(76) Inventors: Edward Grinshpun, Freehold, NJ (US); Semyon B. Mizikovsky, Morganville, NJ (US)

Correspondence Address: Docket Administrator (Room 2F-192), Alcatel Lucent 600, Mountain Avenue, Murray Hill, NJ, 07974-0636, US

(21) Appl. No.: 12/586,979

(22) Filed: Sep. 30, 2009

Related U.S. Application Data
(60) Provisional application No. 61/198,919, filed on Nov. 12, 2008.

(51) Int. Cl. H04W 36/00

(52) U.S. Cl. 370/331

(57) ABSTRACT

A method is provided for optimizing the sending of a Mobile IP Revocation Reply. According to the invention methodology, a Foreign Agent operating as the care-of address for a given mobile unit will send to the Home Agent for that mobile unit a Revocation Acknowledgement message immediately after receiving a Revocation message from the Home Agent, without awaiting the conclusion of the Foreign Agent's tear-down steps. After sending that immediate acknowledgement to the Home Agent, the Foreign Agent independently proceeds with its regular procedures of forwarding the Revocation message to the client (as needed), waiting for a response from the client (including retransmitting the request to the client on a timer if no response received), and tearing down the user plane. With the method of the invention, the latency of the latter procedures would not result in a delay in sending the Revocation Acknowledgement from the Foreign Agent to the Home Agent.

### RELATED APPLICATIONS

This application claims priority pursuant to 35 U.S.C. Sec 119(e) to U.S. Provisional Application No. 61/198,919, filed Nov. 12, 2009, entitled “METHOD FOR SENDING MIP REVOCATION REPLY IN WIRELESS ACCESS NETWORKS,” the subject matter thereof being fully incorporated herein by reference.

### FIELD OF THE INVENTION

The present invention generally relates to network reconfiguration in wireless communication systems.

### BACKGROUND OF THE INVENTION

Wireless communication systems use a geographically-dispersed network of interconnected base stations to provide wireless connectivity to mobile units. The network operates according to standards and/or protocols that allow roaming mobile units to hand off between the interconnected base stations so that call sessions are not interrupted when the mobile unit moves between geographic areas (or cells) served by different base stations. One example of a communication protocol that supports user mobility is Mobile Internet Protocol (Mobile IP). Mobile IP is an Internet Engineering Task Force (IETF) protocol that allows mobile units to move from one network to another while maintaining a permanent IP address throughout the session that requires mobility. A mobile unit that operates according to Mobile IP is assigned, for the duration of the session, a permanent IP address called a home address on its home network, and a care-of address that identifies the current location of the mobile unit within a network and its subnets.

A control plane entity called a home agent stores information about mobile units that have a permanent home address in the home agent's network. Foreign agents store information about mobile units that are visiting the foreign agent's network, and advertise care-of addresses to these mobile units.

Each time a mobile unit moves to a different network, it acquires a new care-of address that corresponds to a target foreign agent. A home agent in the home network associates each permanent home address of the mobile with its current care-of address. The mobile node sends the home agent a message to establish a binding between the home address and care-of address each time it changes its care-of address, using a Mobile IP protocol defined in IETF RFC 3344. When traffic is sent to the mobile unit, the packets are addressed to, and initially received by the home agent, and forwarded via tunneling mechanisms to the appropriate care-of address—typically the foreign agent at the mobile unit's current location.

In cases when the Mobility Client is co-located with the mobile unit, the Mobile IPv4 protocol is instantiated between the Mobility Client, the foreign agent, and the home agent in a configuration which is otherwise called Client Mobile IPv4, or CMIPv4. In cases when the Mobility Client is not present in the mobile unit, the Mobility Client may be invoked at the network node performing the proxy MIP function on behalf of the mobile in a configuration called Proxy MIP, or PMIPv4.

In Version 4 of the Mobile IP protocol (hereafter, generally designated as “MIPv4”), a Registration Revocation message triggered by the MIP Home Agent (hereafter, generally designated as “HA”) is used to gracefully tear down a MIP session. Upon negotiation of MIP revocation support (by the mobility agent), the HA-initiated MIP revocation procedure consists of the HA sending a Revocation message to the MIP Foreign Agent (hereafter, generally designated as “FA”), and the FA, after removing session context, replying with a Revocation Acknowledgment message. The HA continues keeping binding context (without passing the user plane traffic) until it receives an acknowledgement from the FA—designated as a “Revocation Ack” message. In the event no Revocation Ack is received by the HA within a time interval, the HA retransmits the Revocation message to the FA.

When network reconfiguration is performed, the HA may be sending Revocation messages for a large number of Mobile Stations during a very short period of time. Typically the FA would need to tear down the resources associated with serving the user plane for the client, and in addition, the FA has to forward the revocation request to the client either in the form of the actual revocation message in a CMIP case, or as a technology-specific message (e.g., WiMAX message from FA to PMIP client/Authenticator over R4 interface).

It should be noted that the revocation requests may need to be retransmitted between the FA in a serving network and the CMIPv4 in the mobile device due to the limited reliability of the transmission path, thus increasing the latency of the whole revocation process. Similarly, in the PMIP case, the revocation requests may need to be retransmitted between the FA in the serving network and the non-collocated node hosting PMIP client, as well as between the FA and wireless access technology-specific base stations, plus possible over-the-air communications between the base station and the mobile unit to tear down the connection. During the time required for these transmissions and retransmissions, the HA has to maintain the binding associated with the session which is due to be revoked. To avoid associated delay with HA operations, it is important that Revocation Ack messages from the FA arrives at the HA without delays and so the HA resources can be released as soon as possible.

### SUMMARY OF INVENTION

A method is provided for optimizing the sending of an MIP Revocation Reply. According to the invention methodology, an FA will send to the HA a Revocation Ack message immediately after receiving a Revocation request message from the HA, without awaiting the conclusion of the FA's tear-down steps. After sending that immediate acknowledgement to the HA, the FA independently proceeds with its regular procedures of forwarding the Revocation message to the client (as needed), waiting for a response from the client (including retransmitting the request to the client on a timer if no response received), and tearing down the user plane. With the method of the invention, the latency of the latter procedures would not result in a delay in sending the Revocation Ack from the FA to the HA.

### BRIEF DESCRIPTION OF THE FIGURES

The teachings of the present invention can be readily understood by considering the following detailed description in conjunction with the accompanying drawings, in which:

FIG. 1 depicts a timing sequence for connection tear-down as occurs in an application of the art.

FIG. 2 shows a timing sequence for connection tear-down according to the method of the invention.

### DETAILED DESCRIPTION

In the following description, for purposes of explanation and not limitation, specific details are set forth such as particular architectures, interfaces, techniques, etc., in order to provide a thorough understanding of illustrative embodiments of the invention. However, it will be apparent to those skilled in the art that the invention may be practiced in other illustrative embodiments that depart from these specific details. In some instances, detailed descriptions of well-known devices, circuits, and methods are omitted so as not to obscure the description of described embodiments with unnecessary detail. All principles, aspects, and embodiments, as well as specific examples thereof, are intended to encompass both structural and functional equivalents thereof. Additionally, it is intended that such equivalents include both currently known equivalents as well as equivalents developed in the future.

The invention is described hereafter in terms of its application in a Mobile IP system, and particularly in terms of a WiMAX application in a Mobile IP system. It should be clear, however, that the invention is applicable to any Mobile IP application, and that the use of a WiMAX application in the description following is solely for purposes of illustrating the invention principles, and is not in any way intended to limit the scope of the invention.

As a preface to discussion of the invention methodology, the procedure by which an MIP session is presently ended, using the Revocation message procedure, will be briefly considered for context. In the existing art, the FA sends a Revocation Acknowledgement message to the HA only after tearing down the user plane, forwarding the Revocation message to the client and receiving Acknowledgement from the client. In addition, for wireless equipment, tearing down the user plane at the FA involves additional communications between the network node hosting the FA function and wireless access technology-specific base stations, plus possible over-the-air communications between the base station and the mobile unit to tear down the connection.

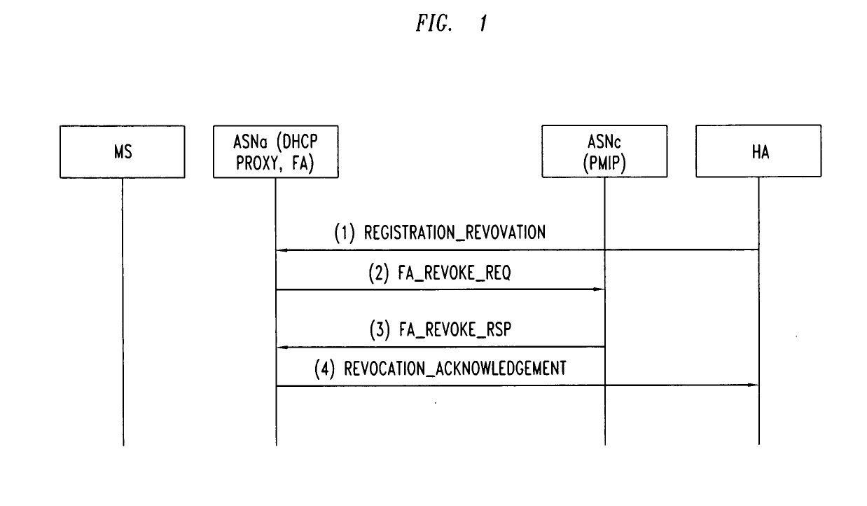

The current Revocation message tear-down procedure is usefully illustrated by the procedure defined by the WiMAX Forum Network Working Group (NWG), which is illustrated in FIG. 1 and described below:

Step 1
The HA initiates the session release with the FA by sending a Registration_Revocation Message. At this point, the HA starts a timer, T_{Registration}_{_{—}}_{Revocation}, to wait for a Registration_Revocation_Acknowledgement message.

Step 2
Upon the FA receiving the Registration_Revocation message, it sends a FA_Revoke_Req message to the PMIP4 client and starts a T_{FA}_{_{—}}_{Revoke}_{_{—}}_{Req} timer. The timer operates to effect a retransmission of the FA_Revoke_Req message if the response from PMIP client is not received during the timing interval.

Step 3
Upon receipt of the FA_Revoke_Req by the PMIP4 client, PMIP4 client removes the mobile context and sends a FA_Revoke_Rsp message to the FA.

Step 4
When the FA receives the FA_Revoke_Rsp message, it stops the timer T_{FA}_{_{—}}_{Revoke}_{_{—}}_{Req}, deletes the PMIP context of the mobile, and sends a Revocation Acknowledgement message to the HA.

Deletion of the PMIP context in Step 4 also includes tearing down the user plane for the given mobile unit, including removing the corresponding over-the-air flows. This is achieved via WiMAX-specific messages between the ASN Gateway (hosting the FA function) and the base station serving the mobile unit.

Note also that, upon receipt of the Revocation_Acknowledgement message at the HA, the T_{Registration}_{_{—}}_{Revocation} timer is also stopped by the HA.

A deficiency of the procedure as carried out in the art (and described above) is that it contains inherent delay between the FA receiving a Revocation message (First part of step 2) and the sending of the Revocation Ack message from the FA to the HA (last part of step 4). The delay includes the activities of (1) exchanging messages with the PMIP client, (2) the PMIP client removing the context, (3) the FA tearing down the user plane (including exchanging messages with base station—not shown in figure), and the base station tearing down the corresponding flows.

In addition, some messages in the exchange of messages between the FA and the PMIP client might be lost, resulting in further delay and leading to timeout of the FA's T_{FA}_{_{—}}_{Revoke}_{_{—}}_{Req} timer and the consequent retransmission of FA_Revoke_Req message by the FA. This in turn adds to the delay of sending the Revocation Acknowledgement message from the FA to the HA, likely resulting in timeout of the HA's T_{Registration}_{_{—}}_{Revocation} timer, thus causing retransmission of Revocation Message from the HA.

The inventors have developed and disclose herein a new method for optimizing the sending of an MIP Revocation Reply. According to the invention methodology, the FA should reply with a Revocation Ack message immediately after receiving a Revocation message from the HA, without awaiting the conclusion of the FA's tear-down steps. After sending that immediate acknowledgement to the HA, the FA independently proceeds with its regular procedures of forwarding the Revocation message to the client (as needed), waiting for a response from the client (including retransmitting the request to the client on a timer if no response received), and tearing down the user plane. With the method of the invention, the latency of the latter procedures would not result in a delay in sending the Revocation Ack from the FA to the HA.

This approach is workable since the FA typically has an independent mechanism to reliably terminate mobility binding with the client (e.g., in the illustrative WiMAX case, using T_{FA}_{_{—}}_{Revoke}_{_{—}}_{Req timer} for retransmission—as shown in FIG. 1). Accordingly, the FA does not need retransmissions of the Revocation message from the HA to reliably perform client context removal in the network.

Also, typically the HA tears down the user plane for the mobile unit being revoked prior to sending the Revocation message to the FA—i.e., after the HA sends the Revocation message to the FA, the HA stops forwarding downlink traffic for the mobile unit to the FA and stops forwarding uplink traffic from the mobile unit being revoked. Therefore it is sufficient for the HA to receive the Revocation Ack message from the FA indicating that FA received the Revocation message. Thus, there is no need to wait until the FA actually notifies the client, removes MIP context for this mobile client and tears down the mobile session.

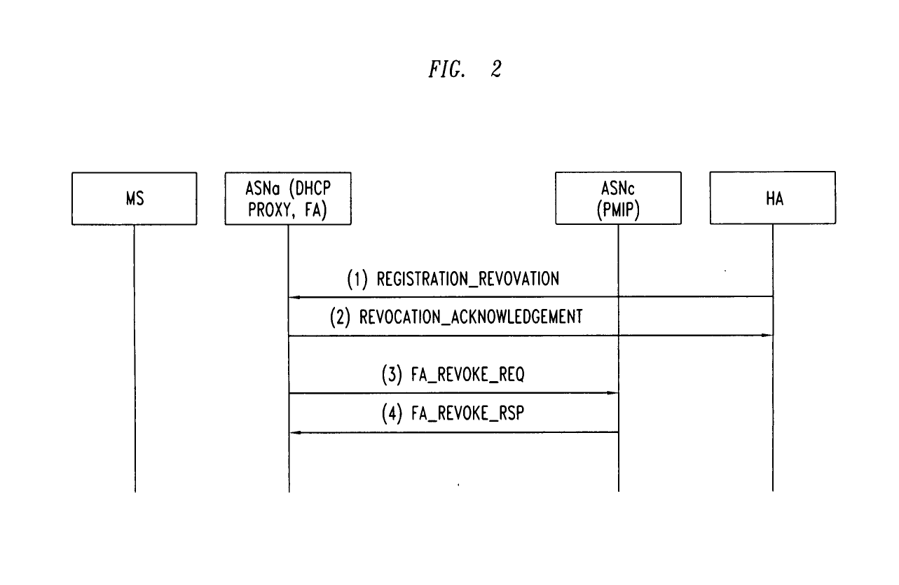

The methodology of the invention is usefully illustrated in the context of a WiMAX access network. Such an exemplary case is depicted in the timing diagram of FIG. 2 and described below:

Step 1
The HA initiates the session release with the FA by sending a Registration_Revocation message to the FA. At this point, the HA starts a timer, T_{Registration}_{_{—}}_{Revocation}, and begins to wait for receipt of the FA acknowledgement message, Registration_Revocation_Acknowledgement. In the event that the FA acknowledgement was not received by the timer timeout, the HA would again transmit the Revocation message to the FA.

Step 2
Upon receipt by the FA of the Registration_Revocation message, the FA sends a Revocation Acknowledgement message to the HA.
When that Revocation_Acknowledgement message is received by the HA, it stops the T_{Registration}_{_{—}}_{Revocation} timer.

Step 3
The FA sends a FA_Revoke_Req message to the PMIP4 client and starts a T_{FA}_{_{—}}_{Revoke}_{_{—}}_{Req} timer. The timer operates to cause the FA to retransmit the FA_Revoke_Req message if the response from PMIP client is not received before timer timeout.

Step 4
Upon receipt by the PMIP4 client of the FA_Revoke_Req message, the PMIP4 client removes the mobile context from the message and sends a FA_Revoke_Rsp message to the FA.
When the FA receives the FA_Revoke_Rsp message from the PMIP4 client, the FA stops the timer T_{FA}_{_{—}}_{Revoke}_{_{—}}_{Req}, and deletes the PMIP context of the mobile unit.

Deletion of the PMIP context in Step 4 also includes tearing down the user plane for the given mobile unit, including removing the corresponding over-the-air flows. For the illustrative WiMAX case, this is achieved via WiMAX-specific messages between the ASN Gateway (hosting the FA function) and base station serving the mobile unit.

The method of the invention may also provide FA bi-casting if multiple interfaces are active at once. In that case, packets are duplicated, properly framed for each active L2 connection and sent via a corresponding interface. Such bi-casting according to the invention methodology is characterized as FA bi-casting, which is unlike HA bi-casting in that the packets are duplicated in the FA, rather than in HA. It may be possible to achieve a better transmission performance using FA bi-casting in the presence of high data error rate in interfaces.

Herein, the inventors have disclosed a method for providing reduced latency in link tear-downs for Mobile IP networks. Numerous modifications and alternative embodiments of the invention will be apparent to those skilled in the art in view of the foregoing description.

Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention, and that the exclusive use of all modifications which come within the scope of the appended claims is reserved.

1. A method for termination of a connection in a wireless communication network, the method comprising:
providing a first entity in the wireless communication network for maintaining a permanent address for a given mobile unit served by the wireless communication network;
providing a second entity in the wireless communication network for maintaining a care-of address for the mobile unit, the care-of address related to a current location of the mobile unit;
sending a message from the first entity to the second entity instructing the second entity that a network link with an identified mobile unit shall be terminated;
upon receipt by the second entity of the link-termination message from the first entity, sending an immediate message to the first entity acknowledging such receipt;
concluding the termination process at the first entity upon receipt of the acknowledgement message from the second entity.

2. The method of claim 1 wherein the second entity proceeds to communicate termination instructions to the identified mobility client subsequent to sending the acknowledgement message to the first entity.

3. The method of claim 1 wherein the wireless network implements a Mobile IP protocol, and the first and second entities are a Home Agent and a Foreign Agent respectively.
